(19) United States
(12) Patent Application Publication
(10) Pub. No.: US 2005/0149416 A1
(43) Pub. Date: Jul. 7, 2005

(54) Network support for graduated airtime billing

(75) Inventors: David S. Benco, Winfield, IL (US); Sandra Lynn True, St. Charles, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2518, US

(73) Assignee: Lucent Technologies Inc.

(21) Appl. No.: 10/752,050

(22) Filed: Jan. 6, 2004

(51) Int. Cl. G06F 17/60

(52) U.S. Cl. 705/34

(57) ABSTRACT

Airtime consumed by a subscriber in excess of calling plan limits is billed at a discounted rate from a reference rate associated with the calling plan. Increasing discounts may be applied as airtime consumption increases. Discounts may be customized on a per subscriber bases. For example, the number of years a subscriber has been a customer and/or the cost of the calling play may be included in a discount calculation. A billing processor includes a graduated biller.

### BACKGROUND

This disclosure is related to the art of providing communication services. Embodiments will be described with reference to methods and systems for charging for airtime in mobile communications networks. However, embodiments may be applied wherever products or services may be charged for on a per unit basis.

Presently, mobile communications services are contracted for on the basis of a calling plan. For instance, a subscriber is allocated a certain amount of airtime in exchange for paying a flat monthly fee. The airtime allocation may be in the form of several sub-allocations associated with various airtime categories. For example, a first sub-allocation might be associated with a daytime or peak period airtime category. A second sub-allocation might be associated with a nighttime, weekend or off peak airtime category. For instance, the airtime allocation might include 100 peak period minutes and 500 off peak period minutes in exchange for a flat fee of $29.95.

If a subscriber consumes bandwidth or airtime in excess of the airtime allocation or in excess of one or more of the sub-allocations, the subscriber is charged for the excess airtime at a relatively high rate.

It may have been assumed that charging a high rate for airtime in excess of a subscriber's calling plan limits or thresholds would: 1) increase revenue to service providers and 2) encourage subscribers to upgrade service plans to ones providing higher airtime allocations in exchange for higher basic fees. However, in at least some cases, these high overcharges have a different effect.

Instead of upgrading their mobile communications service plans, some subscribers react to high per minute fees by being parsimonious with their basic airtime allocation and make every effort to stay within the limits or thresholds established by their calling plans.

As a result, these subscribers do not reap the full benefits that their mobile communication service could provide and mobile communications services providers are not collecting all the revenue that they could.

Therefore, there is a desire for new systems and methods for charging for communication services or airtime that will encourage subscribers to use mobile communications services more freely, thereby increasing mobile communications subscriber satisfaction and revenue generation for communication services providers.

### SUMMARY

A method for charging a subscriber for airtime in a manner that encourages airtime usage includes determining a first reference billing rate for a first category of airtime, determining a first threshold airtime amount for the first category of airtime, determining a quantity of first category airtime consumed by the subscriber, determining a first discounted billing rate for the first category of airtime that is less than the first reference rate and charging the first discounted billing rate for at least some first category airtime consumed by the subscriber in excess of the first threshold airtime amount.

The method can include charging the first reference rate for an amount of first category airtime consumed by the subscriber up to the first threshold airtime amount. Alternatively, the method can include charging a flat fee for first category airtime consumed by the subscriber up to the first threshold airtime amount.

The method can also include determining a second threshold airtime amount, greater than the first threshold airtime amount, determining a second discounted billing rate for the first category of airtime that is less than the first discounted rate and charging the second discounted billing rate for at least some first category airtime consumed by the subscriber in excess of the second threshold airtime amount.

Additionally, the method can include determining a third threshold airtime amount, greater than the second threshold airtime amount, determining a third discounted billing rate for the first category of airtime that is less than the second discounted rate and charging the third discounted billing rate for at least some first category airtime consumed by the subscriber in excess of the third threshold airtime amount.

Furthermore, the method can include determining a fourth threshold airtime amount, greater than the third threshold airtime amount, determining a fourth discounted billing rate for the first category of airtime that is less than the third discounted rate and charging the fourth discounted billing rate for at least some first category airtime consumed by the subscriber in excess of the fourth threshold airtime amount.

Some embodiments include determining a second reference billing rate for a second category of airtime, determining a second category first threshold airtime amount, determining a quantity of second category airtime consumed by the subscriber, determining a second category first discounted billing rate for the second category of airtime less than the second reference rate, charging the second category first discounted billing rate for at least some second category airtime consumed by the subscriber in excess of the second category first threshold airtime amount.

Some of those embodiments include charging the second reference rate for second category airtime consumed by the subscriber up to the second category first threshold airtime amount.

Some embodiments include charging a flat fee for second category airtime consumed by the subscriber up to the second category first threshold airtime amount.

Some include determining a second category second threshold airtime amount, greater than the second category first threshold airtime amount, determining a second category second discounted billing rate for the second category of airtime that is less than the second category first discounted rate and charging the second category second discounted billing rate for at least some second category airtime consumed by the subscriber in excess of the second category second threshold airtime amount.

Some of those include determining a second category third threshold airtime amount, greater than the second category second threshold airtime amount, determining a second category third discounted billing rate for the second category of airtime that is less than the second category second discounted rate and charging the second category third discounted billing rate for at least some second category airtime consumed by the subscriber in excess of the second category third threshold airtime amount.

Furthermore, some of those embodiments include determining a second category fourth threshold airtime amount, greater than the second category third threshold airtime amount, determining a second category fourth discounted billing rate for the second category of airtime that is less than the second category third discounted rate and charging the second category fourth discounted billing rate for at least some second category airtime consumed by the subscriber in excess of the second category fourth threshold airtime amount.

Determining a first discounted billing rate for the first category of airtime that is less than the first reference rate can include determining a time period the subscriber has been a customer and determining the first discounted billing rate based on a function of the time period the subscriber has been a customer that generates a larger discounts for longer customer time periods.

In some embodiments, determining a first discounted billing rate for the first category of airtime that is less than the first reference rate includes determining a calling plan subscription cost of the subscriber and determining the first discounted billing rate based on a function of the calling plan subscription cost of the subscriber that generates a larger discounts for higher cost subscription plans.

In some embodiments, determining a first discounted billing rate for the first category of airtime that is less than the first reference rate includes determining a time period the subscriber has been a customer, determining a calling plan subscription cost of the subscriber and determining the first discounted billing rate based on a function of the time period the subscriber has been a customer and of the calling plan subscription cost of the subscriber that generates larger discounts for longer customer time periods and higher cost subscription plans.

An exemplary embodiment is a method for charging a subscriber for airtime that includes associating one or more reference billing rates with a respective one or more airtime categories in a calling plan, determining one or more respective discounted billing strategies for charging for airtime consumed by the subscriber in excess of one or more calling plan limits associated with a calling plan of the subscriber, determining one or more airtime amounts in the one or more airtime categories consumed by the subscriber in an airtime billing period, applying one of, the one or more reference billing rates and a flat fee, for respective portions of the one or more airtime amounts that are within the one or more calling plan limits to determine basic charges, applying the one or more discounted billing strategies to portions of the one or more airtime amounts that are in excess of the calling plan to determine discounted surcharges and combining the basic charges and discounted surcharges to determine a total charge for the subscriber for the billing period.

Determining one or more respective discounted billing strategies can include selecting one or more airtime consumption thresholds for each of the one or more air time categories and calculating one or more discounted billing rate associated with the one or more airtime consumption thresholds based on a function of at least one of a time period the subscriber has been a customer, a calling plan subscription cost of the subscriber and the amount of airtime consumed in one or more airtime categories during a period of interest, the function selected to generate larger discounts for at least one of longer customer time periods, higher cost subscription plans and the amount of airtime consumed in the one or more airtime categories.

Determining one or more respective discounted billing strategies can include calculating one or more discounted billing rates based on a function of at least one of a time period the subscriber has been a customer and a calling plan subscription cost of the subscriber, and the amount of airtime consumed in one or more airtime categories during a period of interest, the function selected to generate larger discounts for at least one of longer customer time periods and higher cost subscription plans, and the amount of airtime consumed in the one or more airtime categories during the period of interest.

Determining one or more airtime amounts can include processing call detail records generated by calls associated with the subscriber during the billing period.

A system for charging a subscriber for airtime can include means for determining a first reference billing rate for a first category of airtime, means for determining a first threshold airtime amount, means for determining a quantity of first category airtime consumed by the subscriber, means for determining a first discounted billing rate for the first category of airtime that is less than the first reference rate and means for charging the first discounted billing rate for at least some first category airtime consumed by the subscriber in excess of the first threshold airtime amount.

The system of can further include means for determining a second threshold airtime amount, greater than the first threshold airtime amount, means for determining a second discounted billing rate for the first category of airtime that is less than the first discounted rate and means for charging the second discounted billing rate for at least some first category airtime consumed by the subscriber in excess of the second threshold airtime amount.

Additionally, the system can include means for determining a third threshold airtime amount, greater than the second threshold airtime amount, means for determining a third discounted billing rate for the first category of airtime that is less than the second discounted rate and means for charging the third discounted billing rate for at least some first category airtime consumed by the subscriber in excess of the third threshold airtime amount.

Furthermore, the system can include means for determining a fourth threshold airtime amount, greater than the third threshold airtime amount, means for determining a fourth discounted billing rate for the first category of airtime that is less than the third discounted rate, and means for charging the fourth discounted billing rate for at least some first category airtime consumed by the subscriber in excess of the fourth threshold airtime amount.

Some embodiments include means for determining a second reference billing rate for a second category of airtime, means for determining a second category first threshold airtime amount, means for determining a quantity of second category airtime consumed by the subscriber, means for determining a second category first discounted billing rate for the second category of airtime less than the second reference rate and means for charging the second category first discounted billing rate for at least some second category airtime consumed by the subscriber in excess of the second category first threshold airtime amount.

Some of those embodiments include means for charging the second reference rate for second category airtime consumed by the subscriber up to the second category first threshold airtime amount and some include means for charging a flat fee for second category airtime consumed by the subscriber up to the second category first threshold airtime amount.

Furthermore, some embodiments include means for determining a second category second threshold airtime amount, greater than the second category first threshold airtime amount, means for determining a second category second discounted billing rate for the second category of airtime that is less than the second category first discounted rate and means for charging the second category second discounted billing rate for at least some second category airtime consumed by the subscriber in excess of the second category second threshold airtime amount.

Additionally, the system can include means for determining a second category third threshold airtime amount, greater than the second category second threshold airtime amount, means for determining a second category third discounted billing rate for the second category of airtime that is less than the second category second discounted rate and means for charging the second category third discounted billing rate for at least some second category airtime consumed by the subscriber in excess of the second category third threshold airtime amount.

Some embodiments also include means for determining a second category fourth threshold airtime amount, greater than the second category third threshold airtime amount, means for determining a second category fourth discounted billing rate for the second category of airtime that is less than the second category third discounted rate and means for charging the second category fourth discounted billing rate for at least some second category airtime consumed by the subscriber in excess of the second category fourth threshold airtime amount.

The means for determining a first discounted billing rate for the first category of airtime that is less than the first reference rate can include means for determining a time period the subscriber has been a customer and means for determining the first discounted billing rate based on a function of the time period the subscriber has been a customer that generates a larger discounts for longer customer time periods.

In some embodiments the means for determining a first discounted billing rate for the first category of airtime that is less than the first reference rate includes means for determining a calling plan subscription cost of the subscriber and means for determining the first discounted billing rate based on a function of the calling plan subscription cost of the subscriber that generates a larger discounts for higher cost subscription plans.

In some embodiments the means for determining a first discounted billing rate for the first category of airtime that is less than the first reference rate includes means for determining a time period the subscriber has been a customer, means for determining a calling plan subscription cost of the subscriber and means for determining the first discounted billing rate based on a function of the time period the subscriber has been a customer and of the calling plan subscription cost of the subscriber that generates larger discounts for longer customer time periods and higher cost subscription plans.

An exemplary system operative to charge a progressively lower rate for airtime consumed by a subscriber during a billing period includes a call record reviewer operative to determine one or more total quantities of airtime consumed in one or more airtime categories during the billing period and an graduated biller operative to apply one or more charges for portions of the one or more total quantities of airtime that are below one or more threshold quantities and to apply at least one discounted billing rate to one or more portions of the one or more total quantities of airtime that are above the one or more threshold quantities of airtime.

The graduated biller can be operative to apply a flat rate charge for portions of the one or more total quantities of airtime that are below one or more calling plan limits.

In some embodiments the graduated biller is operative to apply a charge based on one or more reference billing rates for portions of the one or more total quantities of airtime that are below one or more calling plan limits.

In some embodiments the graduated biller is operative to apply at least one discounted billing rate, relative to at least one reference billing rate associated with portions of the one or more total quantities of airtime that are below one or more calling plan limits, to portions of the one or more total quantities of airtime that are above one or more calling plan limits.

Sometimes the graduated biller is operative to apply a first discounted billing rate to a portion of a total quantity of a consumed airtime in a first airtime category above a first airtime category first threshold quantity and below a first airtime category second quantity threshold. Additionally, the graduated biller can be operative to apply a second discounted billing rate to a portion of a total quantity of a consumed airtime in a first airtime category above the first airtime category second threshold quantity and below a first airtime category third threshold quantity.

In some embodiments the graduated biller is operative to apply a continuously increasingly discounted billing rate to a portion of a total quantity of a consumed airtime in a first airtime category above a first airtime category threshold quantity. Additionally, or alternatively, the graduated biller can be operative to apply a first discounted billing rate based a function of the time period the subscriber has been a customer that generates a larger discounts for longer customer time periods. The first discounted billing rate can also be based on a function of the calling plan subscription cost of the subscriber that generates a larger discount for higher cost subscription plans.

In some embodiments the graduated biller is operative to apply a first discounted billing rate based on a function of the time period the subscriber has been a customer and of the calling plan subscription cost of the subscriber that generates larger discounts for longer customer time periods and higher cost subscription plans.

The continuously increasingly discounted billing rate mentioned about can also be a function of the time period the subscriber has been a customer that generates a larger discounts for longer customer time periods and the amount of airtime consumed in a first airtime category, a function of the calling plan subscription cost of the subscriber that generates a larger discounts for higher cost subscription plans and the amount of airtime consumed in a first airtime category and/or a function of the time period the subscriber has been a customer, the calling plan subscription cost of the subscriber that generates larger discounts for longer customer time periods and higher cost subscription plans and the amount of airtime consumed in a first airtime category.

### BRIEF DESCRIPTION OF THE DRAWINGS

The invention may take form in various components and arrangements of components, and/or in various procedures and arrangements of procedures. The drawings are only for purposes of illustrating preferred embodiments. They are not to scale, and are not to be construed as limiting the invention.

FIG. 1 is a flowchart outlining a method for charging for airtime.

FIG. 2 is a graph showing graduated discounted billing rates.

FIG. 3 is a table showing discounted billing rates determined through the use of an exemplary discount function or equation.

FIG. 4 is a block diagram of an exemplary system operative to perform the method of FIG. 1.

### DETAILED DESCRIPTION

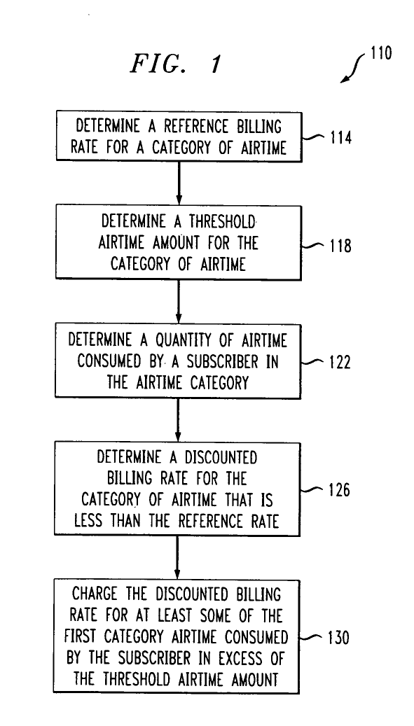

Referring to FIG. 1, a method for charging a subscriber for airtime includes determining 114 a reference billing rate for a category of airtime, determining 118 a threshold airtime amount for the category of airtime, determining 122 a quantity of airtime consumed by a subscriber in the airtime category, determining 126 a discounted billing rate for the category of airtime that is less than the reference rate, and charging the discounted billing rate for at least some first category airtime consumed by the subscriber in excess of the threshold airtime amount.

Where a calling plan has only one category of airtime, determining 114 a reference billing rate for that category of airtime is relatively simple. For instance, where a calling plan has no basic allocation of airtime per billing period then the reference rate is the rate at which airtime is billed according to the calling plan. For instance, if the first minute of airtime is billed at $0.20 per minute independent of the time of the day or the day of the week during which the airtime is consumed, then the reference billing rate is easily determined 114 to be $0.20 per minute.

Alternatively, a subscriber might be allocated 200 “anytime” minutes per month or per billing period and the basic billing period fee might be $20. The subscriber pays $20 per billing period (e.g., month) independent of the amount of airtime consumed during that month, as long as the airtime consumed does not exceed the airtime limit or threshold of 200 minutes. In this case, the reference billing rate for these “anytime” minutes might be determined to be $20+200 minutes=$0.10 per minute.

Where calling plans are more complicated, including sub-allocations or allocations according to airtime categories, then determining 114 a reference billing rate for one or more of those categories may become something of an art, involving decisions based on market psychology as well as mathematics. For instance, where a calling plan provides an airtime allocation including a 100 minute peak period airtime category sub-allocation and a 500 minute off peak airtime category sub-allocation, for a flat billing period fee of $60, the reference billing rate for the first category of airtime (peak) might be selected to be $0.35/min, while a reference billing rate for the second category of airtime (off peak) is selected to be $0.05/min. In this example, $35 of the $60 flat fee is considered to be the flat fee for the 100 peak period minutes. $25 of the $60 flat fee is considered to be the flat fee for the 500 off peak minutes. However, other allocations or distributions are possible.

As explained above, an element of the method 110 for charging a subscriber for airtime is determining 126 a discounted billing rate for the category of airtime in question that is less than the reference rate. The degree of success of the method 110 in encouraging subscribers to consume communications services in excess of basic plan allocations may depend to some degree on the perception of the subscriber as to whether or not the determined 126 discounted billing rate is an actual discount from the rate that was being charged for in the plan minutes. Therefore, determining 114 a reference billing rate for each category of airtime may be based on market research and/or trial and error procedures.

Determining 118 a threshold airtime amount for a category of airtime may include simply noting the airtime limits for the category of airtime within a calling plan. For instance, in the example presented above, a first threshold airtime for the peak billing period category is 100 minutes. A first threshold airtime amount for the second or off peak airtime category is 500 minutes.

However, in some embodiments of the method 110 for charging a subscriber for airtime, a plurality of threshold airtime amounts are determined 118 for a given airtime category, and a plurality of increasing discounts are determined 126 and applied 130 as the amount of airtime consumed by the subscriber (in the particular category) increases beyond each of the plurality of thresholds.

For example, referring to FIG. 2, a first reference rate 214 is charged for airtime minutes consumed in a first airtime category under a first category first threshold 218. Between the first threshold 218 and a first category second threshold 222 a first discounted rate 226 is applied. If the subscriber consumes airtime in excess of the second threshold 222 then, a second discounted rate 230, less than the first discounted rate 226, is charged 130 for airtime consumed up to a first category third threshold amount 234. For airtime consumed in excess of the third threshold amount 234, a third discounted rate 238, less than the second discounted rate 230, is applied. A first category fourth threshold 242 and others may be applied as the minutes consumed by the subscriber in the airtime category of interest continue to increase. Alternatively, the third discounted rate 238 may be applied to all minutes consumed in the airtime category of interest in excess of the third threshold 234.

Determining 122 a quantity of airtime consumed by the subscriber can include, for example, reviewing Call Detail Records (CDRs) associated with calls to and from the subscriber (or user equipment thereof). All applicable Call Detail Records for the billing period are reviewed and a total or cumulative airtime consumed in each applicable airtime category is determined.

Determining 126 the discounted billing rate for the category of airtime of interest, that is less than the reference rate, can be accomplished a number of ways. For example, a service provider may simply decide that for a given calling plan, airtime consumed in excess of the calling plan limits is billed at 80 % of the determined 114 reference rate. Alternatively, several rates may be associated with several determined 118 thresholds (e.g., 218, 222, 234). For instance, where a first threshold for peak category airtime is 100 minutes, airtime in excess of 100 minutes, but less than a peak category second threshold of, for example, 200 minutes, might be billed at 90% of the referenced billing rate. Airtime in excess of 200 minutes but less than 300 minutes might be (i.e., a peak category third threshold) billed at 80% of the reference rate for the peak airtime category. Airtime in excess of 300 minutes is billed at 70% of the reference billing rate.

Alternatively, the determined 126 discounted billing rate is customizable to individual customers. For instance, the discounted billing rate is determined 126 in a manner that encourages subscriber loyalty to a service provider and encourages communications services consumption. For example, referring to Eq. (1):

$${D}_{CT} = \frac{1}{( {B}_{T}^{Y} ( BPBC / {BP}_{min} ) )} \qquad Eq . ( 1 )$$

A discount D_{CT} associated with a particular airtime category (C) and threshold airtime amount (T) can be a function of a billing period basic charge (BPBC), a minimum billing period charge (BPₘᵢₙ), a base figure selected for a given threshold airtime amount (B_{T}), and a number of years (Y) the subscriber has been a customer of the communications services provider.

The billing period minimum charge (BPₘᵢₙ) can be, for example, the cost of the lowest priced calling plan offered by the communications services provider.

The billing period basic charge (BPBC) is, for example, the basic charge of the calling plan contracted for by the subscriber.

As shown in exemplary Eq.(1), the base (B_{T}) selected for a given threshold airtime amount (B_{T}) is a constant selected so that the equation generates the desired discount values. Alternatively, the base (B_{T}) might be selected to be a function of the bandwidth, or number of airtime minutes, consumed by the subscriber during a billing period of interest. This would allow the discount rate D_{CT} to increase continuously (i.e., the rate charged is a continuously decreasing percentage of the reference rate) so that each subsequent minute, or measure of bandwidth, costs the subscriber less than the preceding minute (or unit of measure).

In the exemplary discount calculating equation (Eq.(1)) the base (B_{T}) carries an exponent equal to the number of years (Y) the subscriber has been a customer of the service provider. This has the effect of increasing the discount applied to services consumed by the subscriber (in excess of the determined 118 for the category of airtime of interest) for subscribers who have been customers of the service provider for a longer period of time. It is assumed that increasing the discount based on the length of time a subscriber has been a customer will encourage customer loyalty.

The denominator of the discount calculation equation (Eq.(1)) includes a factor that is the ratio of the billing period basic charge of the calling plan of the subscriber (BPBC) and the minimum billing period charge (BPₘᵢₙ) associated with the least expensive calling plan offered by the service provider. This has the effect of increasing the discount (D_{CT}) rate applied to minutes or bandwidth consumed by subscribers having more expensive calling plans. This may provide an incentive to the subscriber to contract for calling plans that have increased basic or flat fees.

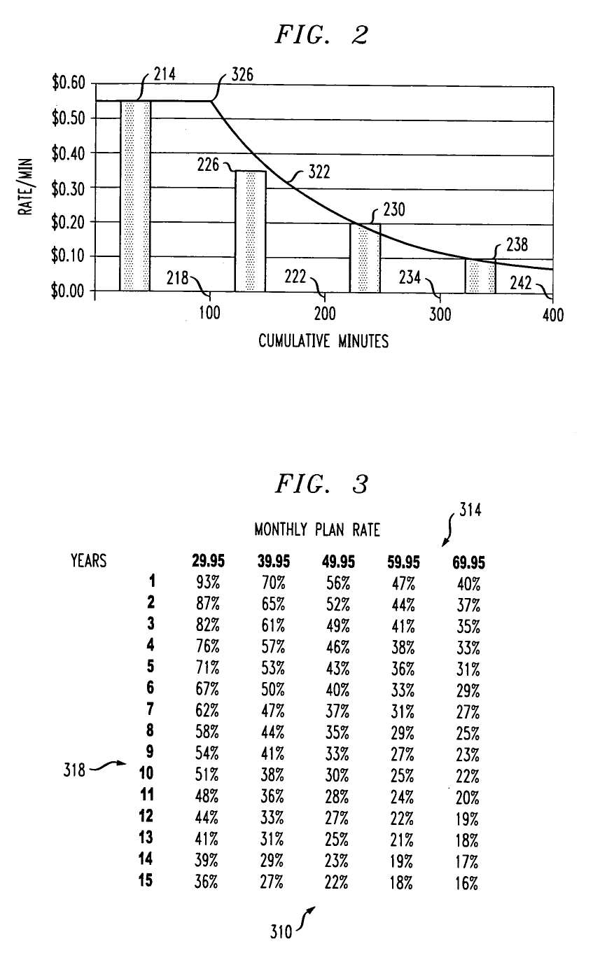

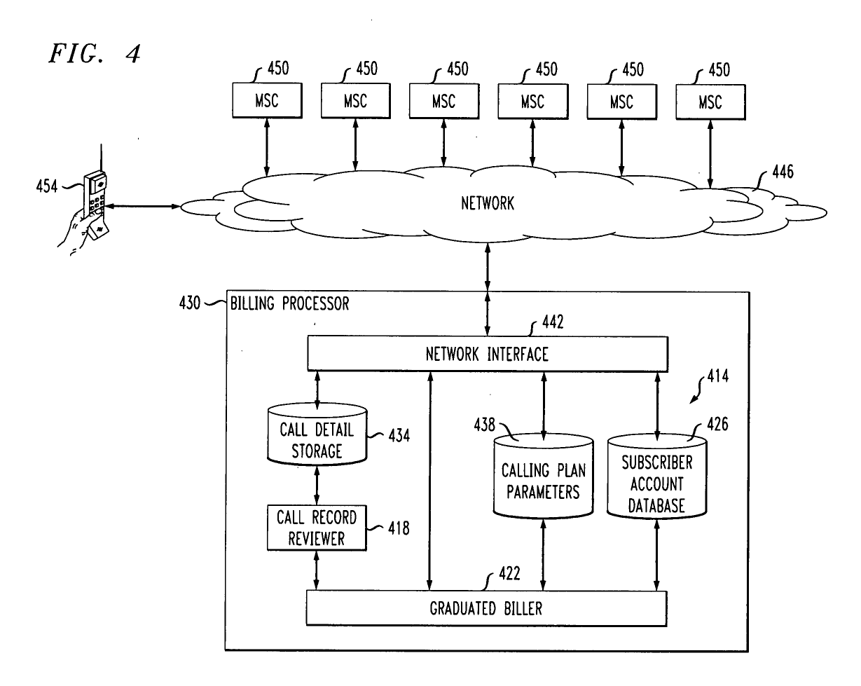

FIG. 3 provides a table 310 showing discount factors (D_{CT}) generated by equation 1 for various billing period basic charges 314 and a range of years 318 that the subscriber has been a customer of the service provider. This table 310 of values is generated by Eq.(1) when the base (B_{T}) has a selected value of 1.07 and the minimum billing period basic charge (BPₘᵢₙ) is $29.95.

Of course, Eq.(1) is exemplary only. Discount rates can be calculated based on a subset of the suggested factors, based on additional factors, and/or based on different factors. For instance, the minimum billing period basic charge (BPₘᵢₙ) can be replaced with some other constant or function. Similarly, the discount rate (D_{CT}) need not be a function of the billing period basic charge (BPBC) or the number of years (Y) a subscriber has been a customer.

The determined 114 reference rate for a given category is multiplied by the discount fraction or percentage (e.g., Eq.(1), FIG. 3) for that category in order to determine 126 the discounted billing rate for that category and associated threshold. The discounted billing rate is then applied to the appropriate consumed services (airtime, bandwidth, etc.).

The method 110 for charging a subscriber for airtime or bandwidth can be repeated or extended to be applied to all airtime categories in a calling plan of the subscriber. As explained with reference to FIG. 2, additional thresholds (e.g., 222, 234) can be determined 118 for each of the categories of airtime in the subscribers calling plan to provide increasing discounts as the subscribers airtime usage increases. A first airtime category can be associated with a first threshold amount, second threshold amount, third threshold amount and so on. Furthermore, a second airtime category can be associated with a determined 118 second airtime category first threshold amount, second threshold airtime amount, third threshold airtime amount and so on. Third, fourth and fifth airtime categories and more can also be associated with respective first, second and third airtime threshold amounts. Indeed, an infinite number of thresholds can be associated with each airtime category.

For example, where the base (B_{T}) described in reference to Eq.(1) is a function of airtime consumed by the subscriber, the discount charged 130 may change for each minute of airtime consumed. In that case, a threshold airtime amount is determined 118 for, or at, each cumulative minute mark. For example, a continuous rate curve 322 (in FIG. 2) shows a continuous discount rate change after a first threshold or breakpoint 326 associated with a calling plan limit for the related category of airtime. The discount rate curve 322 can be thought of as being associated with an infinite number of threshold amounts, one threshold amount for each minute (or other unit of measure) along the X axis of the graph of FIG. 2.

Referring to FIG. 4, a system 414 operative to charge a progressively lower rate for airtime consumed by a subscriber includes a Call Record Reviewer 418 and a Graduated Biller 422. Additionally, the system may include a Subscriber Account Database 426.

For instance, the system 414 is included within a Billing Processor 430. The Billing Processor 430 also includes a Call Detail Storage 434 and some record of Calling Plan Parameters 438. Additionally the Billing Processor 430 includes a Network Interface 442 for communicating with components of a communications Network 446.

In some embodiments, the system 414 (including the Call Record Reviewer 418 and the Graduated Biller 422) is implemented in software run by a computational element (e.g., microprocessor) of the Billing Processor 430. The system 414 may be included in newly manufactured network elements or be included as updates to call record reviewing and bill calculating components of existing network elements. In some embodiments, the system 414 is considered to be implemented in a combination of hardware and software. Embodiments implemented almost entirely in hardware, (such as, for example, state machine based embodiments) are also contemplated.

The call record reviewer is operative to determine one or more total quantities of airtime consumed in one or more airtime categories during a billing period. For example, during the billing period, as Mobile Switching Centers (MSCs) 450 process calls associated with user equipment 454 of the subscriber, they generate and accumulate Call Detail Records (CDR) documenting, for example, the time and length of calls engaged in by the subscriber. The MSCs transmit the call detail records to the Billing Processor 430. The Billing Processor 430 stores the Call Detail Records in the Call Detail Storage 434. At the end of the billing period, the Call Record Reviewer 418 extracts Call Detail Records from the Call Detail Storage 434 and determines 122 the quantity of airtime consumed by the subscriber in each airtime category associated with the calling plan of the subscriber. For example, the Call Record Reviewer 418 determines a total number of peak airtime minutes and a total number of off peak airtime minutes consumed by the subscriber. The call record reviewer 418 makes those totals available to the Graduated Biller 422.

The Graduated Biller 422 is operative to apply one or more charges for portions of the one or more total quantities of airtime that are below one or more threshold quantities and to apply (charge 130) at least one discounted billing rate to one or more portions of the one or more total quantities of airtime that are above the one or more threshold quantities of airtime. For example, the graduated biller 422 is operative to apply a determined 114 reference rate (e.g., 214) or a flat rate or charge for portions of the total quantities of airtime reported by the Call Record Reviewer 418 that are below one or more thresholds or calling plan limits (e.g., 218, 326). Additionally, the Graduated Biller 422 determines 126 one or more discounted billing rates for one or more categories of airtime associated with the calling plan of the subscriber. The determined 126 discounted billing rates are less than the determined 114 reference billing rate.

For example, if the subscriber consumed airtime (in all categories) within the limits prescribed by the calling plan contracted for by the subscriber, the Graduated Biller 422 simply charges the basic fee called for by the subscriber's calling plan. The Graduated Biller 422 receives calling plan information from the Subscriber Account Database 426 and the Calling Plan Parameters 438 known to the Billing Processor 430.

However, for each category of airtime that the Call Record Reviewer 418 reports that the subscriber has exceeded a calling plan limit or determined 118 airtime amount threshold, the Graduated Biller 422 determines 126 one or more discounted billing rates and charges 130 an account of the subscriber according to the one or more determined 126 discounted billing rates. For example, the Graduated Biller 422 applies 130 a first discounted billing rate (e.g., 226) to all airtime consumed above a first threshold (e.g., 218), but below a second threshold (e.g., 222), a second discounted billing rate (e.g., 230) for all cumulative minutes consumed above the second threshold (e.g., 222) but less than the third threshold (e.g., 234). If the subscriber consumed airtime in excess of the third threshold then the Graduated Biller 422 applies a third discounted billing rate that is less than the second discounted billing rate 230, which in turn is less than the first discounted billing rate 226.

The discounted billing rates may be the same for all subscribers and for all calling plans. Alternatively, the determined 126 discounted billing rates may be functions of characteristics associated with the subscriber. For example, as described in reference to Eq.(1), discounted billing rates may be determined 126 based on a function of a time period the subscriber has been a customer of the service provider, the cost of the subscription or calling plan of the subscriber and/or the number of minutes or bandwidth consumed by the subscriber. The discounts may be applied in discrete bands as illustrated in FIG. 2 (226, 230, 238) or in a continuous manner (e.g., 322). Different discount rates may be determined 126 for each category of airtime.

Where discounts are customized on a per subscriber basis (e.g., Eq. (1)), the Graduated Biller 422 accesses the customizing information from the Subscriber Account Database 426. For instance, the Graduated Biller 422 queries the Database 426 and retrieves a number of years the subscriber has been a customer of the service provider and/or the cost of the subscribers calling plan. The Graduated Biller 422 includes the customizing parameters in the customizing calculation (e.g., Eq.(1)), determines a discounted billing rate by, for example, multiplying the results of the customizing function by the determined 114 reference billing rate for the airtime category of interest, and generates the charge 130 for the portion of the airtime consumed by the subscriber being processed (e.g., the portion between the first threshold of the category (e.g., 218) and the second threshold of the category (e.g., 222), or the portion between the second threshold of the category (e.g., 222) and the third threshold of the category (e.g., 234) or the portion beyond the third threshold of the category (e.g., 234). The Graduated Biller 422 repeats these procedures (126, 130) for each quantity of airtime determined 122 to have been consumed by the subscriber in excess of a threshold amount. When all categories of airtime have been accounted for, a final set of charges 130 is transmitted via the network interface 422 to other components of the network 446, which generate a bill, which is transmitted (e.g., mailed) to the subscriber.

The invention has been described with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

1. A method for charging a subscriber for airtime, the method comprising:
determining a first reference billing rate for a first category of airtime;
determining a first threshold airtime amount for the first category of airtime;
determining a quantity of first category airtime consumed by the subscriber;
determining a first discounted billing rate for the first category of airtime that is less than the first reference rate; and,
charging the first discounted billing rate for at least some first category airtime consumed by the subscriber in excess of the first threshold airtime amount.

2. The method of claim 1 further comprising:
charging the first reference rate for an amount of first category airtime consumed by the subscriber up to the first threshold airtime amount.

3. The method of claim 1 further comprising:
charging a flat fee for first category airtime consumed by the subscriber up to the first threshold airtime amount.

4. The method of claim 1 further comprising:
determining a second threshold airtime amount, greater than the first threshold airtime amount;
determining a second discounted billing rate for the first category of airtime that is less than the first discounted rate; and
charging the second discounted billing rate for at least some first category airtime consumed by the subscriber in excess of the second threshold airtime amount.

5. The method of claim 4 further comprising:
determining a third threshold airtime amount, greater than the second threshold airtime amount;
determining a third discounted billing rate for the first category of airtime that is less than the second discounted rate; and
charging the third discounted billing rate for at least some first category airtime consumed by the subscriber in excess of the third threshold airtime amount.

6. The method of claim 5 further comprising:
determining a fourth threshold airtime amount, greater than the third threshold airtime amount;
determining a fourth discounted billing rate for the first category of airtime that is less than the third discounted rate; and,
charging the fourth discounted billing rate for at least some first category airtime consumed by the subscriber in excess of the fourth threshold airtime amount.

7. The method of claim 1 further comprising:
determining a second reference billing rate for a second category of airtime;
determining a second category first threshold airtime amount;
determining a quantity of second category airtime consumed by the subscriber;
determining a second category first discounted billing rate for the second category of airtime less than the second reference rate;
charging the second category first discounted billing rate for at least some second category airtime consumed by the subscriber in excess of the second category first threshold airtime amount.

8. The method of claim 7 further comprising:
charging the second reference rate for second category airtime consumed by the subscriber up to the second category first threshold airtime amount.

9. The method of claim 7 further comprising:
charging a flat fee for second category airtime consumed by the subscriber up to the second category first threshold airtime amount.

10. The method of claim 7 further comprising
determining a second category second threshold airtime amount, greater than the second category first threshold airtime amount;
determining a second category second discounted billing rate for the second category of airtime that is less than the second category first discounted rate; and
charging the second category second discounted billing rate for at least some second category airtime consumed by the subscriber in excess of the second category second threshold airtime amount.

11. The method of claim 10 further comprising
determining a second category third threshold airtime amount, greater than the second category second threshold airtime amount;
determining a second category third discounted billing rate for the second category of airtime that is less than the second category second discounted rate; and
charging the second category third discounted billing rate for at least some second category airtime consumed by the subscriber in excess of the second category third threshold airtime amount.

12. The method of claim 11 further comprising:
determining a second category fourth threshold airtime amount, greater than the second category third threshold airtime amount;
determining a second category fourth discounted billing rate for the second category of airtime that is less than the second category third discounted rate; and
charging the second category fourth discounted billing rate for at least some second category airtime consumed by the subscriber in excess of the second category fourth threshold airtime amount.

13. The method of claim 1 wherein determining a first discounted billing rate for the first category of airtime that is less than the first reference rate comprises:
determining a time period the subscriber has been a customer; and,
determining the first discounted billing rate based on a function of the time period the subscriber has been a customer that generates a larger discount for longer customer time periods.

14. The method of claim 1 wherein determining a first discounted billing rate for the first category of airtime that is less than the first reference rate comprises:
determining a calling plan subscription cost of the subscriber; and,
determining the first discounted billing rate based on a function of the calling plan subscription cost of the subscriber that generates a larger discounts for higher cost subscription plans.

15. The method of claim 1 wherein determining a first discounted billing rate for the first category of airtime that is less than the first reference rate comprises:
determining a time period the subscriber has been a customer;
determining a calling plan subscription cost of the subscriber; and,
determining the first discounted billing rate based on a function of the time period the subscriber has been a customer and of the calling plan subscription cost of the subscriber that generates larger discounts for longer customer time periods and higher cost subscription plans.

16. A method for charging a subscriber for airtime, the method comprising:
associating one or more reference billing rates with a respective one or more airtime categories in a calling plan;
determining one or more respective discounted billing strategies for charging for airtime consumed by the subscriber in excess of one or more calling plan limits associated with a calling plan of the subscriber;
determining one or more airtime amounts in the one or more airtime categories consumed by the subscriber in an airtime billing period;
applying one of, the one or more reference billing rates and a flat fee, for respective portions of the one or more airtime amounts that are within the one or more calling plan limit to determine basic charges;
applying the one or more discounted billing strategies to portions of the one or more airtime amounts that are in excess of the calling plan to determine discounted surcharges; and
combining the basic charges and discounted surcharges to determine a total charge for the subscriber for the billing period.

17. The method of claim 16 wherein determining one or more respective discounted billing strategies comprises:
selecting one or more airtime consumption thresholds for each of the one or more air time categories; and,
calculating one or more discounted billing rate associated with the one or more airtime consumption thresholds based on a function of at least one of a time period the subscriber has been a customer, a calling plan subscription cost of the subscriber and the amount of airtime consumed in one or more airtime categories during a period of interest, the function selected to generate larger discounts for at least one of longer customer time periods, higher cost subscription plans and the amount of airtime consumed in the one or more airtime categories.

18. The method of claim 16 wherein determining one or more respective discounted billing strategies comprises:
calculating one or more discounted billing rates based on a function of at least one of a time period the subscriber has been a customer and a calling plan subscription cost of the subscriber, and the amount of airtime consumed in one or more airtime categories during a period of interest, the function selected to generate larger discounts for at least one of longer customer time periods and higher cost subscription plans, and the amount of airtime consumed in the one or more airtime categories during the period of interest.

19. The method of claim 16 wherein determining one or more airtime amounts comprises:
processing call detail records generated by calls associated with the subscriber during the billing period.

20. A system for charging a subscriber for airtime, the method comprising:
means for determining a first reference billing rate for a first category of airtime;
means for determining a first threshold airtime amount;
means for determining a quantity of first category airtime consumed by the subscriber;
means for determining a first discounted billing rate for the first category of airtime that is less than the first reference rate; and,
means for charging the first discounted billing rate for at least some first category airtime consumed by the subscriber in excess of the first threshold airtime amount.

21. The system of claim 20 further comprising:
means for charging the first reference rate for an amount of first category airtime consumed by the subscriber up to the first threshold airtime amount.

22. The system of claim 20 further comprising:
means for charging a flat fee for first category airtime consumed by the subscriber up to the first threshold airtime amount.

23. The system of claim 20 further comprising:
means for determining a second threshold airtime amount, greater than the first threshold airtime amount;
means for determining a second discounted billing rate for the first category of airtime that is less than the first discounted rate; and
means for charging the second discounted billing rate for at least some first category airtime consumed by the subscriber in excess of the second threshold airtime amount.

24. The system of claim 23 further comprising:
means for determining a third threshold airtime amount, greater than the second threshold airtime amount;
means for determining a third discounted billing rate for the first category of airtime that is less than the second discounted rate; and
means for charging the third discounted billing rate for at least some first category airtime consumed by the subscriber in excess of the third threshold airtime amount.

25. The system of claim 24 further comprising:
means for determining a fourth threshold airtime amount, greater than the third threshold airtime amount;
means for determining a fourth discounted billing rate for the first category of airtime that is less than the third discounted rate; and
means for charging the fourth discounted billing rate for at least some first category airtime consumed by the subscriber in excess of the fourth threshold airtime amount.

26. The system of claim 20 further comprising:
means for determining a second reference billing rate for a second category of airtime;
means for determining a second category first threshold airtime amount;
means for determining a quantity of second category airtime consumed by the subscriber;
means for determining a second category first discounted billing rate for the second category of airtime less than the second reference rate; and,
means for charging the second category first discounted billing rate for at least some second category airtime consumed by the subscriber in excess of the second category first threshold airtime amount.

27. The system of claim 26 further comprising:
means for charging the second reference rate for second category airtime consumed by the subscriber up to the second category first threshold airtime amount.

28. The system of claim 26 further comprising:
means for charging a flat fee for second category airtime consumed by the subscriber up to the second category first threshold airtime amount.

29. The system of claim 26 further comprising:
means for determining a second category second threshold airtime amount, greater than the second category first threshold airtime amount;
means for determining a second category second discounted billing rate for the second category of airtime that is less than the second category first discounted rate; and
means for charging the second category second discounted billing rate for at least some second category airtime consumed by the subscriber in excess of the second category second threshold airtime amount.

30. The system of claim 29 further comprising:
means for determining a second category third threshold airtime amount, greater than the second category second threshold airtime amount;
means for determining a second category third discounted billing rate for the second category of airtime that is less than the second category second discounted rate; and
means for charging the second category third discounted billing rate for at least some second category airtime consumed by the subscriber in excess of the second category third threshold airtime amount.

31. The system of claim 30 further comprising:
means for determining a second category fourth threshold airtime amount, greater than the second category third threshold airtime amount;
means for determining a second category fourth discounted billing rate for the second category of airtime that is less than the second category third discounted rate; and
means for charging the second category fourth discounted billing rate for at least some second category airtime consumed by the subscriber in excess of the second category fourth threshold airtime amount.

32. The system of claim 20 wherein the means for determining a first discounted billing rate for the first category of airtime that is less than the first reference rate comprises:
means for determining a time period the subscriber has been a customer; and,
means for determining the first discounted billing rate based on a function of the time period the subscriber has been a customer that generates a larger discounts for longer customer time periods.

33. The system of claim 20 wherein the means for determining a first discounted billing rate for the first category of airtime that is less than the first reference rate comprises:
means for determining a calling plan subscription cost of the subscriber; and
means for determining the first discounted billing rate based on a function of the calling plan subscription cost of the subscriber that generates a larger discount for higher cost subscription plans.

34. The system of claim 20 wherein the means for determining a first discounted billing rate for the first category of airtime that is less than the first reference rate comprises:
means for determining a time period the subscriber has been a customer;
means for determining a calling plan subscription cost of the subscriber; and,
means for determining the first discounted billing rate based on a function of the time period the subscriber has been a customer and of the calling plan subscription cost of the subscriber that generates larger discounts for longer customer time periods and higher cost subscription plans.

35. A system operative to charge a progressively lower rate for airtime consumed by a subscriber during a billing period, the system comprising:
a call record reviewer operative to determine one or more total quantities of airtime consumed in one or more airtime categories during the billing period; and,
an graduated biller operative to apply one or more charges for portions of the one or more total quantities of airtime that are below one or more threshold quantities and to apply at least one discounted billing rate to one or more portions of the one or more total quantities of airtime that are above the one or more threshold quantities of airtime.

36. The system of claim 35 wherein the graduated biller is operative to apply a flat rate charge for portions of the one or more total quantities of airtime that are below one or more calling plan limits.

37. The system of claim 35 wherein the graduated biller is operative to apply a charge based on one or more reference billing rates for portions of the one or more total quantities of airtime that are below one or more calling plan limits.

38. The system of claim 35 wherein the graduated biller is operative to apply at least one discounted billing rate, relative to at least one reference billing rate associated with portions of the one or more total quantities of airtime that are below one or more calling plan limits, to portions of the one or more total quantities of airtime that are above one or more calling plan limits.

39. The system of claim 35 wherein the graduated biller is operative to apply a first discounted billing rate to a portion of a total quantity of a consumed airtime in a first airtime category above a first airtime category first threshold quantity and below a first airtime category second quantity threshold.

40. The system of claim 39 wherein the graduated biller is operative to apply a second discounted billing rate to a portion of a total quantity of a consumed airtime in a first airtime category above the first airtime category second threshold quantity and below a first airtime category third threshold quantity.

41. The system of claim 35 wherein the graduated biller is operative to apply a continuously increasingly discounted billing rate to a portion of a total quantity of a consumed airtime in a first airtime category above a first airtime category threshold quantity.

42. The system of claim 35 wherein the graduated biller is operative to apply a first discounted billing rate based a function of the time period the subscriber has been a customer that generates a larger discounts for longer customer time periods.

43. The system of claim 35 wherein the graduated biller is operative to apply a first discounted billing rate based on a function of the calling plan subscription cost of the subscriber that generates a larger discount for higher cost subscription plans.

44. The system of claim 35 wherein the graduated biller is operative to apply a first discounted billing rate based on a function of the time period the subscriber has been a customer and of the calling plan subscription cost of the subscriber that generates larger discounts for longer customer time periods and higher cost subscription plans.

45. The system of claim 36 wherein the continuously increasingly discounted billing rate is a function of the time period the subscriber has been a customer that generates a larger discounts for longer customer time periods and the amount of airtime consumed in a first airtime category.

46. The system of claim 35 wherein the continuously increasingly discounted billing rate is a function of the calling plan subscription cost of the subscriber that generates a larger discounts for higher cost subscription plans and the amount of airtime consumed in a first airtime category.

47. The system of claim 35 wherein the continuously increasingly discounted billing rate is a function of the time period the subscriber has been a customer, the calling plan subscription cost of the subscriber that generates larger discounts for longer customer time periods and higher cost subscription plans and the amount of airtime consumed in a first airtime category.
